(19) United States
(12) Patent Application Publication
(10) Pub. No.: US 2012/0034576 A1
(43) Pub. Date: Feb. 9, 2012

(54) DENTAL CLEANING DEVICE

(76) Inventor: Hani Mostafa Awadalla Mostafa, Warwickshire (GB)

(21) Appl. No.: 13/263,238

(22) PCT Filed: Apr. 21, 2010
(86) PCT No.: PCT/GB10/50646

§ 371 Date: Oct. 6, 2011

(30) Foreign Application Priority Data
Apr. 24, 2009 (GB) 0907061.6

(51) Int. Cl. A61C 17/00; A46B 9/04

(52) U.S. Cl. 433/153; 15/167.1; 15/167.2

(57) ABSTRACT

A dental cleaning device (10) comprising cleaning elements (12) arranged in a spaced relationship and angled generally towards one another such that a space (14) is defined there between. The cleaning elements (12) being movable to increase the space (14) to thereby enable the cleaning elements (12) to be located on either side of part of a tooth. Each cleaning element (12) acts to control the angle of the other cleaning element (12) relative to the tooth and gum, to ensure that the cleaning elements (12) engage the tooth and gum at an angle, so that the cleaning elements (12) can clean between the tooth and the gum.

The invention relates to a dental cleaning device.

Periodontal disease is a gum disease which affects the tissue and bone that supports the teeth. Contraindications of periodontal disease include gum inflammation in the area around the teeth and gum bleeding during brushing. As the disease progresses, the gum recedes and there is loss of supporting bone beneath the gum, resulting in tooth mobility and loss. Periodontal disease is caused by bacteria present on the gum and teeth and can be treated by specific oral hygiene methods and specialist cleaning, carried out by a dental surgeon or dental hygienist. Treatment and prevention of the disease in susceptible individuals would be improved if appropriate cleaning could also be carried out by a patient.

An aspect of the invention provides a dental cleaning device comprising a cleaning element and a guide element arranged in a spaced relationship with the cleaning element angled generally towards the guide element such that a space is defined between the cleaning element and the guide element, at least one of the cleaning element and the guide element being movable to increase the space to thereby enable the cleaning element and the guide element to be located either side of part of a tooth.

The dental cleaning device facilitates cleaning between the tooth and adjacent gum by the angled cleaning element. The guide element acts to control the angle of the cleaning element relative to the tooth and gum, to ensure that the cleaning element engages the tooth and gum at an angle, so that the cleaning element can clean between the tooth and the gum.

Preferably, the cleaning element is provided on a first arm and the guide element is provided on a second arm, the first and second arms being arranged in a spaced relationship. The cleaning device can thus be easily used in relation to teeth at the back of the mouth.

At least one of the first arm and the second arm may comprise a section of a flexible material towards one end thereof, the at least one of the cleaning element and the guide element being provided generally at said one end such that it is movable by deflection of the said section.

Preferably, each of the first arm and the second arm comprises a first section at said one end and a second section at the other end, the first section being arranged at an angle to the second section. The cleaning element and the guide element can thus be located at a tooth at the back of the mouth without the arms fouling on the front teeth.

Preferably, the guide element comprises a further cleaning element, which is angled generally towards the cleaning element. The dental cleaning device can thus be used in relation to teeth on both sides of the mouth. The further cleaning element may also be movable to increase the space.

The or each cleaning element may comprise a flexible cleaning element and is thus movable by deflection. The or each cleaning element may comprise a bristle set. The bristle set may have a generally circular cross-section and generally pointed at its distal end. The bristle set is preferably of the type generally used on interspace brushes and is smaller than an adult molar, which it is adapted to clean. The or each cleaning element may further comprise an additional set of bristles provided around the bristle set, the additional set of bristles having a shorter length than the bristle set, such that the bristle set extends beyond the additional set of bristles.

Preferably, the or each cleaning element is provided on a movably mounted cleaning head. The cleaning head may be linearly movable such that the or each cleaning element may be linearly movable to increase the space. The cleaning head may alternatively or additionally be rotatably movable and the dental cleaning device may further comprise drive means operable to cause rotation of the cleaning head.

The dental cleaning device may further comprise coupling apparatus adapted to couple the device to a handle.

Alternatively, the dental cleaning device may further comprise a handle, which may have an angled shape to facilitate location of the cleaning element and guide element at teeth at the back of the mouth without fouling on the front teeth.

Embodiments of the invention will now be described in detail, by way of example only, with reference to the accompanying drawings, in which:

FIG. 1 is a diagrammatic representation of a dental cleaning device of a first embodiment of the invention;

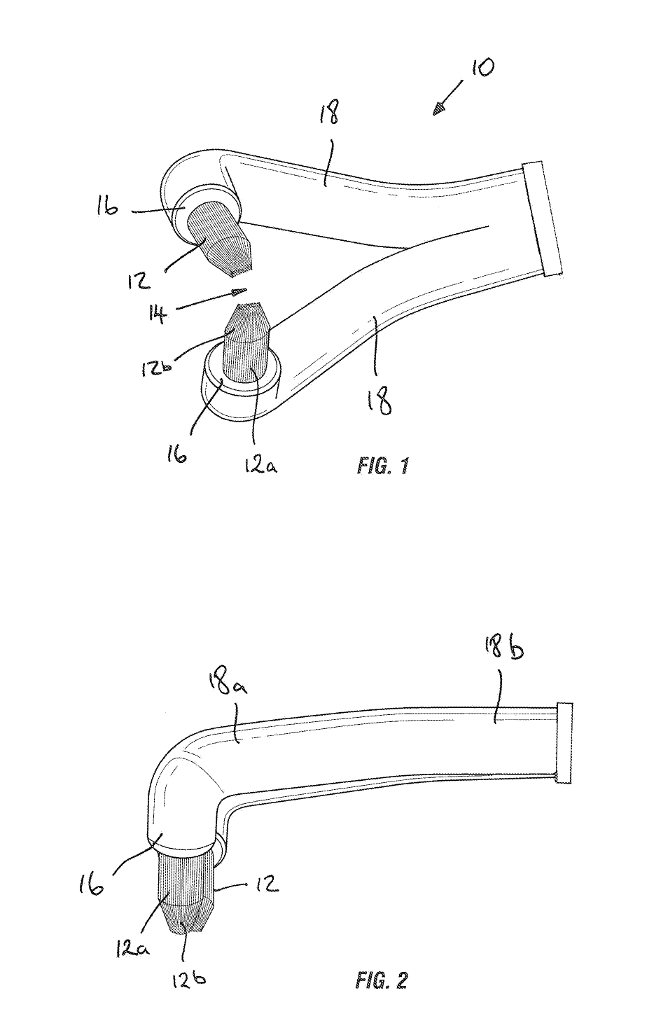

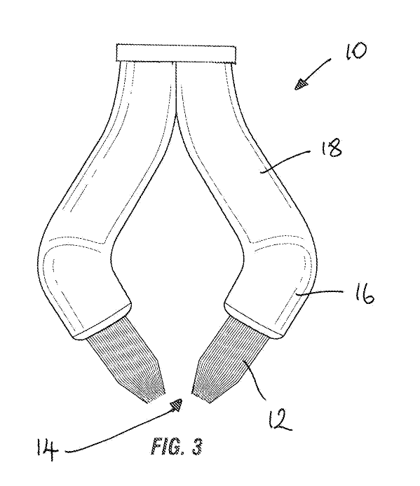

FIG. 2 is a diagrammatic side view of the device of FIG. 1;

FIG. 3 is a diagrammatic end view of the device of FIG. 1;

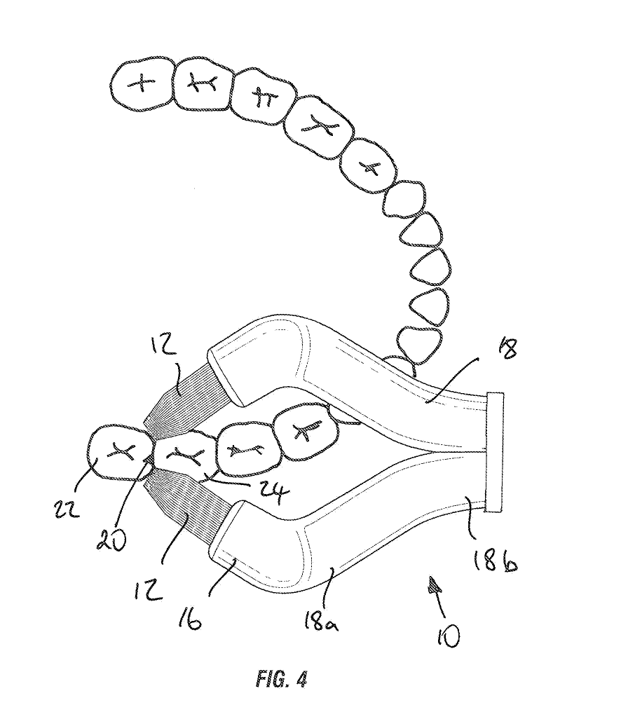

FIG. 4 shows a diagrammatic representation of the device of FIG. 1 in use on a set of lower teeth;

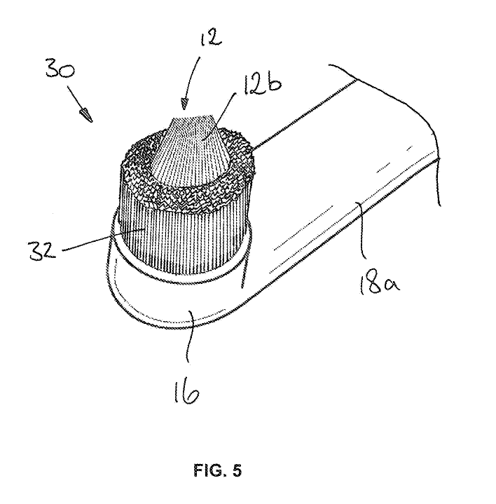

FIG. 5 is a diagrammatic representation of a cleaning head and cleaning element for a dental cleaning device according to a second embodiment of the invention; and

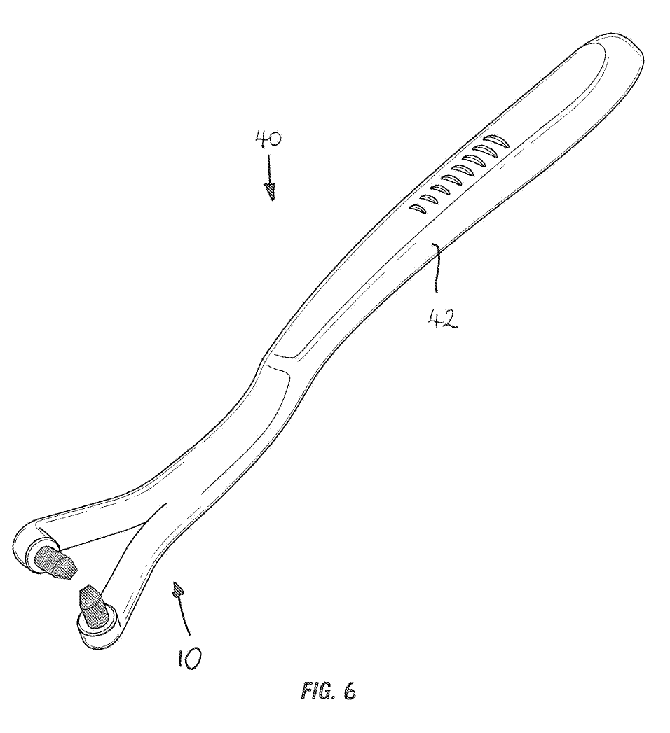

FIG. 6 is a diagrammatic representation of a dental cleaning device of a third embodiment of the invention.

Referring to FIGS. 1 to 3, a first embodiment of the invention provides a dental cleaning device 10 comprising first and second cleaning elements 12 arranged in a spaced relationship, with the cleaning elements 12 angled generally towards one another, such that a space 14 is defined between the cleaning elements 12.

In this example, the cleaning elements 12 comprise bristle sets but it will be appreciated that other suitable cleaning elements may alternatively be used. Each cleaning element 12 is provided on a cleaning head 16. The bristle sets 12 have a generally cylindrical shaped first section 12a connected to the cleaning head 16 and a generally rounded pointed distal end section 12b, similar to the type of bristle sets used on interspace brushes. The distal ends 12b of the bristle sets are smaller than the molars 22, 24 that the bristle sets 12 are adapted to clean. The bristle sets 12 each have a maximum height of 12-15 mm, a maximum diameter of 3-6 mm and a width across the rounded point of the distal end section 12b of 1-2 mm.

The cleaning heads 16 are carried by first and second arms 18. Each arm 18 comprises a first section 18a at one end and a second section 18b at its other end. The cleaning head 16 is provided at and forms the distal end of the first section 18a. The cleaning head 16 is angled generally downwardly (as orientated in FIG. 2) and away from the first section 18a. The cleaning head 16 is additionally angled inwardly (as orientated in FIGS. 1 and 3) such that the two cleaning heads 16 and bristle sets 12 are angled generally towards one another and generally downwardly (as orientated in FIGS. 2 and 3). Coupling apparatus (not shown) are provided internally to the second sections 18b and are adapted to couple the device 10 to a handle.

As shown in FIG. 2, the first section 18a of the arm 18 is angled with respect to the second section 18b. This is to provide clearance height of the second section 18b over the front teeth when the bristle sets 12 are to be located at the back teeth, as shown in FIG. 4.

The second sections 18b of the arms 18 are coupled to one another at their other ends, and the first sections 18a of the arms 18 are arranged in an angled, spaced relationship, as shown in FIGS. 1 and 3.

The first sections 18a of the arms 18 are made of a flexible material, which in this example comprises a thermoplastic but may alternatively comprise nylon. The ends of the first sections 18a, and thus the cleaning heads 16, may therefore be deflected generally outwardly (as orientated in the drawings) in order to increase the size of the space 14 between the bristle sets 12. The bristle sets 12 are also flexible, and may be deflected outwardly in order to locate around a tooth, as shown in FIG. 4.

The space 14 defined by the bristle sets 12 is generally slightly smaller than the width of the junction 20 between two molars 22 to 24, as shown in FIG. 4. In use, the bristle sets 12 are located around the junction 20 and the device is pushed gently downwardly onto the teeth 22, 24, the resulting force causing the first sections 18a of the arms 18 to deflect, and causing the bristles 12 to deflect, so that the bristles 12 pass over the junction 20 and the teeth 22, 24 to come into contact with the gum surrounding the teeth 22, 24.

The bristle set 12 located on the inside of the teeth 22, 24 acts as a guide to ensure that the bristle set 12 on the outside of the teeth 22, 24 is positioned at the correct angle to clean between the teeth 22, 24 and the surrounding gum. Similarly, the bristle set 12 located on the outside of the teeth 22, 24 acts as a guide for the bristle set 12 on the inside of the teeth 22, 24. The bristle sets 12 are thereby arranged in use at an acute angle to the generally vertical sides of the tooth crown, ensuring that the bristles 12 may be located between the tooth crown and the surrounding gum, to thereby clean between the tooth crown and the gum.

The dental cleaning device 10 thereby provides the advantage over toothbrushes and interspace brushes of providing the bristles 12 at the correct angle to clean between the tooth crown and the surrounding gum. Due to the shape and arrangement of known brushes it is very difficult for an unskilled user to locate the bristles at the correct angle in order to clean between the tooth crown and the surrounding gum.

The dental cleaning device 10 may be used to prevent and/or treat periodontal disease, and has been tested in this respect to treat teeth having level 3 mobility. Following regular cleaning using the dental cleaning device 10, tooth mobility was reduced to level 1.

In a further example, the cleaning heads 16 may be rotatably mounted on the arms 18, such that the bristle sets 12 may be rotated during cleaning, in the manner of known mechanical toothbrushes.

A second embodiment of the invention provides a dental cleaning device in which the cleaning element 30 further comprises an additional set of bristles 32 provided around the bristle set 12, as shown in FIG. 5. The additional set of bristles 32 have a length substantially equal to the height of the first section 12a of the respective bristle set, such that the rounded pointed distal end 12b of the bristle set 12 is generally centrally located within the additional set of bristles 32 and appears to extend generally outwardly from the additional set of bristles.

It will be appreciated by the person skilled in the arm that the bristle sets 12 may be replaced by any other suitable cleaning element. In addition, rather than the full length of the first sections 18a of the arms being flexible, only part of the length of the first sections 18a may comprise a flexible material. It may also be sufficient for the cleaning elements to be flexible in order to allow them to be located around the tooth, so that the arms 18 do not need to be flexible themselves. Alternatively, the bristle sets 12 or cleaning elements may be linearly movable within the cleaning head 16, so that the bristle sets 12 may be linearly moved into the cleaning head 16, to thereby increase the size of the space 14 between them.

As will be understood by the person skilled in the art, periodontal disease generally affects the back teeth more than the front teeth, but the cleaning device 10 may be adapted for cleaning front teeth, particularly by arranging the bristle sets 12 to have a smaller space between them.

The dental cleaning device 10 shown in FIGS. 1 to 4 may be mounted on any suitable handle, including handles for known mechanical toothbrushes. Where rotatably mounted cleaning heads 16 are provided, drive apparatus is provided for the cleaning heads 16, within the cleaning device 10, for coupling with a drive source provided within the handle, to drive rotation of the cleaning heads 16 in the known manner.

FIG. 6 shows a dental cleaning device 40 according to a third embodiment of the invention. The dental cleaning device 40 comprises a dental cleaning device 10 according to the first embodiment of the invention and a handle 42. The dental cleaning device 10 and the handle 42 comprise a composite body, such that the device 10 is not removable from the handle 42.

In this example, the handle 42 is angled, in order to provide further clearance over the front teeth, as discussed above.

Various modifications may be made to the described dental cleaning devices 10, 30 without departing from the scope of the invention. In particular, the arms 18 may be provided in a different arrangement, and may for example be generally parallel to one another, and connected via a coupling element at their other ends. The bristle sets 12 may be replaced by an alternative suitable cleaning element. The cleaning heads 16 may have a different angular orientation with respect to the first sections 18a of the arms 18, such that a different sized space 14 is defined between the bristle sets or cleaning elements. The angle of the first sections 18a of the arms 18 to the second sections 18b may be different to that shown. Where the cleaning device 10 is provided with an angled handle the first sections 18a of the arms 18 may be arranged at a smaller angle or no angle to the second sections 18b.

1-12. (canceled)

13. A dental cleaning device comprising:
at least one cleaning element; and
a guide element arranged in a spaced relationship with said cleaning element angled generally towards said guide element such that a space is defined between said cleaning element and said guide element;
wherein at least one of said cleaning element and said guide element being movable to increase said space to thereby enable said cleaning element and said guide element to be located either side of part of a tooth.

14. The device as claimed in claim 13, wherein said cleaning element is provided on a first arm and said guide element is provided on a second arm, said first and second arms being arranged in a spaced relationship.

15. The device as claimed in claim 14, wherein at least one of said first arm and said second arm comprises a section of a flexible material towards one end thereof, at least one of said cleaning element and said guide element being provided generally at said one end such that the said at least one of said cleaning element and said guide element is movable by deflection of the said section.

16. The device as claimed in claim 15, wherein each of said first arm and said second arm comprises a first section at said one end and a second section at an other end, said first section being arranged at an angle to said second section.

17. The device as claimed in claim 16, wherein said guide element comprises a further cleaning element, which is angled generally towards said cleaning element.

18. The device as claimed in claim 17, wherein each of said cleaning elements comprises a flexible cleaning element.

19. The device as claimed in claim 18, wherein each of said cleaning elements comprises a bristle set.

20. The device as claimed in claim 19, wherein said bristle set has a generally circular cross-section and is generally pointed at a distal end of said bristle set.

21. The device as claimed in claim 20, wherein each of said cleaning elements further comprise an additional set of bristles provided around said bristle set, said additional set of bristles having a shorter length than said bristle set, such that said bristle set extends beyond said additional set of bristles.

22. The device as claimed in claim 21, wherein said bristle set is smaller than an adult molar.

23. The device as claimed in claim 22, wherein each of said cleaning elements is provided on a movably mounted cleaning head.

24. The device as claimed in claim 24, wherein said dental cleaning device further comprises a coupling apparatus configured to couple said dental cleaning device to a handle.

25. A dental cleaning device comprising:
a first arm having a first section at one end and a second section at an opposite end of said first section, said first section including a cleaning element provided at a distal end of said first section;
a second arm having a first section at one end and a second section at an opposite end of said second section, said first section of said second arm including a cleaning element provided at a distal end of said first section of said second arm;
wherein said cleaning elements of said first and second arms each being angled substantially downwardly and away from said first section respectively, said cleaning elements of said first and second arms each being further angled toward each other such as to define a space there between, said space being configured to receive a tooth;
wherein at least one of said cleaning elements of said first and second arms each acts to control an angle of the other of said cleaning elements.

26. The device as claimed in claim 25, wherein at least one of said first sections of said first and second arms comprises a section of a flexible material, at least one of said cleaning elements being provided generally at said one end such that the said at least one of said cleaning elements is movable by deflection of the said section.

27. The device as claimed in claim 25, wherein each of said cleaning elements comprises a flexible cleaning element.

28. The device as claimed in claim 25, wherein each of said cleaning elements comprises a bristle set.

29. The device as claimed in claim 28, wherein at least one of said bristle set has a generally circular cross-section and is generally pointed at a distal end of said bristle set.

30. The device as claimed in claim 29, wherein each of said cleaning elements further comprise an additional set of bristles provided around said bristle set, said additional set of bristles having a shorter length than said bristle set, such that said bristle set extends beyond said additional set of bristles.

31. The device as claimed in claim 25, wherein each of said cleaning elements is provided on a movably mounted cleaning head.

32. The device as claimed in claim 25, wherein said dental cleaning device further comprises a coupling apparatus configured to couple said dental cleaning device to a handle.
